(19) United States
(12) Patent Application Publication
(10) Pub. No.: US 2024/0389066 A1
(43) Pub. Date: Nov. 21, 2024

(54) BEAM INFORMATION IN DL-AOD POSITIONING

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 18/686,388

(22) PCT Filed: Sep. 9, 2022
(86) PCT No.: PCT/US2022/043131

§ 371 Date: Feb. 23, 2024

(30) Foreign Application Priority Data
Oct. 29, 2021 (GR) 20210100752

(51) Int. Cl. H04W 64/00; G01S 13/76

(52) U.S. Cl. CPC H04W 64/003; G01S 13/765

(57) ABSTRACT

Method and apparatus for beam information in downlink AoD positioning with UE positioning. The apparatus sends a first request, to at least one base station, for a beam response report based on at least a first location information. The first request includes the first location information with respect to the at least one base station. The apparatus sends a second request, to the at least one base station, for a beam response report based on at least a second location information. The second request includes the second location information with respect to the at least one base station. The apparatus receives, from the at least one base station, one or more beam response reports comprising beam response information of one or more transmission beams of the at least one base station corresponding to at least the first location information and the second location information.

### CROSS-REFERENCE TO RELATED APPLICATION

This application claims the benefit of Greek application Ser. No. 20/210,100752, entitled “BEAM INFORMATION IN DL-AOD POSITIONING” and filed on Oct. 29, 2021, which is expressly incorporated by reference herein in its entirety.

### TECHNICAL FIELD

The present disclosure relates generally to communication systems, and more particularly, to a configuration for beam information in downlink angle of departure (DL-AoD) positioning with UE positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a device at a network entity. The device may be a processor and/or a modem at a network entity or the network entity itself. The apparatus sends a first request, to at least one base station of a set of base stations, for a beam response report based on at least a first location information. The first request includes one or more location information with respect to the at least one base station. The apparatus receives, from the at least one base station, one or more beam response reports comprising beam response information of one or more transmission beams of the at least one base station corresponding to at least the first location information.

In an aspect of the disclosure, a method, a computer-readable medium, and an apparatus are provided. The apparatus may be a device at a base station. The device may be a processor and/or a modem at a base station or the base station itself. The apparatus receives, from a network entity, a request for a beam response report based on at least a first location information. The request includes one or more location information with respect to the base station. The apparatus provides, to the network entity, the beam response report comprising beam response information of one or more transmission beams corresponding to at least the first location information.

In an aspect of the disclosure, a method, a computer-readable medium, and an apparatus are provided. The apparatus may be a device at a UE. The device may be a processor and/or a modem at a UE or the UE itself. The apparatus receives beam response information for a set of downlink angle of departures (DL-AoDs) of at least one base station. The beam response information corresponds to at least one of one or more location information. The apparatus selects a first DL-AoD from the set of DL-AoDs based at least on one of the one or more location information with respect to the at least one base station.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of an angle estimation error of a base station.

FIG. 5 is a diagram illustrating an example of a downlink AoD of a base station.

FIG. 6 is a diagram illustrating an example of a change in a beam pattern of a base station.

FIG. 7 is a diagram illustrating an example of basis function based signaling.

FIGS. 8A and 8B are diagrams illustrating examples of adjusted beams of a base station.

FIG. 9 is a call flow diagram of signaling between a UE, a base station, and a network entity.

FIG. 10 is a flowchart of a method of wireless communication.

FIG. 11 is a flowchart of a method of wireless communication.

FIG. 12 is a diagram illustrating an example of a hardware implementation for an example apparatus.

FIG. 13 is a flowchart of a method of wireless communication.

FIG. 14 is a flowchart of a method of wireless communication.

FIG. 15 is a diagram illustrating an example of a hardware implementation for an example apparatus.

FIG. 16 is a flowchart of a method of wireless communication.

FIG. 17 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

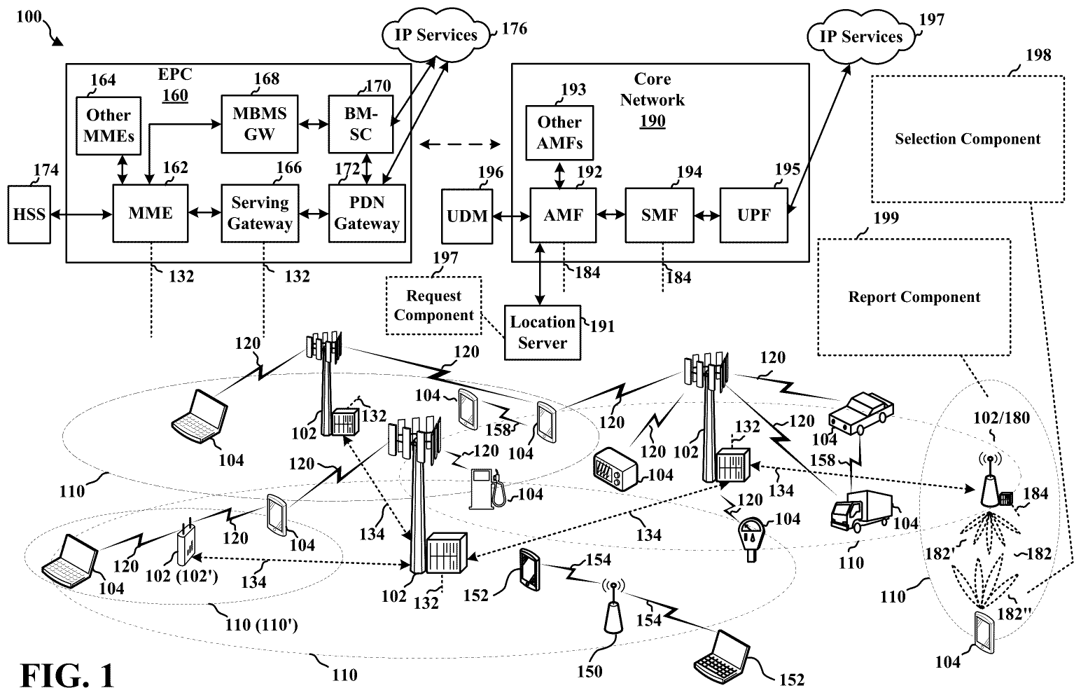

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (cNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHZ (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHZ, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHZ). Although a portion of FRI is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FRI characteristics and/or FR2 characteristics, and thus may effectively extend features of FRI and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHz), FR4 (52.6 GHZ-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FRI, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHZ spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services. In some instances, the core network 190 may communicate with a location server 191. The location server may comprise a location management function (LMF). The location server may be utilized in positioning architecture. The location server may receive measurements and assistance information from the NG-RAN and the UE 104 via the AMF 192. The location server may utilize the measurements and assistance information to compute the position of the UE 104. The location server may provide a positioning configuration to the UE via the AMF. In such instances, the NG-RAN (e.g., base station 102/180) receives the positioning configuration from the AMF and may then provide the positioning configuration to the UE. In some instances, the NG-RAN (e.g., base station 102/180) may configure the UE with the positioning configuration.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the location server 191 may request for a beam response report from at least one base station based at least one or more location information with respect to the at least one base station. For example, the location server 191 may comprise a request component 189 configured to request for a beam response report from at least one base station based at least one or more location information with respect to the at least one base station. The location server 191 may send a first request, to at least one base station 180 of a set of base stations, for a beam response report based on at least a first location information. The first request includes one or more location information with respect to the at least one base station 180. The location server 191 may receive, from the at least one base station 180, one or more beam response reports comprising beam response information of one or more transmission beams of the at least one base station corresponding to at least the first location information.

Referring again to FIG. 1, in certain aspects, the UE 104 may be configured to select a downlink AoD from a set of downlink AoDs based on the UE positioning or a direction of travel of the UE 104. For example, the UE 104 may comprise a selection component 198 configured to select a downlink AoD from a set of downlink AoDs based on the UE positioning or a direction of travel of the UE 104. The UE 104 may receive beam response information for a set of downlink AoDs of at least one base station 180. The beam response information corresponds to at least one of one or more location information. The UE 104 may select a first downlink AoD from the set of downlink AoDs based at least on one of the one or more location information with respect to the at least one base station 180.

Referring again to FIG. 1, in certain aspects, the base station 180 may be configured to provide a beam response report, to a location server, based on at least one or more location information with respect to the base station. For example, the base station 180 may comprise a report component 199 configured to provide a beam response report, to a location server, based on at least one or more location information with respect to the base station. The base station 180 may receive, from a network entity (e.g., location server 191), a request for a beam response report based on at least a first location information. The request includes one or more location information with respect to the base station 180. The base station 180 may provide, to the network entity, the beam response report comprising beam response information of one or more transmission beams corresponding to at least the first location information.

Although the following description may be focused on 5G NR, the concepts described herein may be applicable to other similar areas, such as LTE, LTE-A, CDMA, GSM, and other wireless technologies.

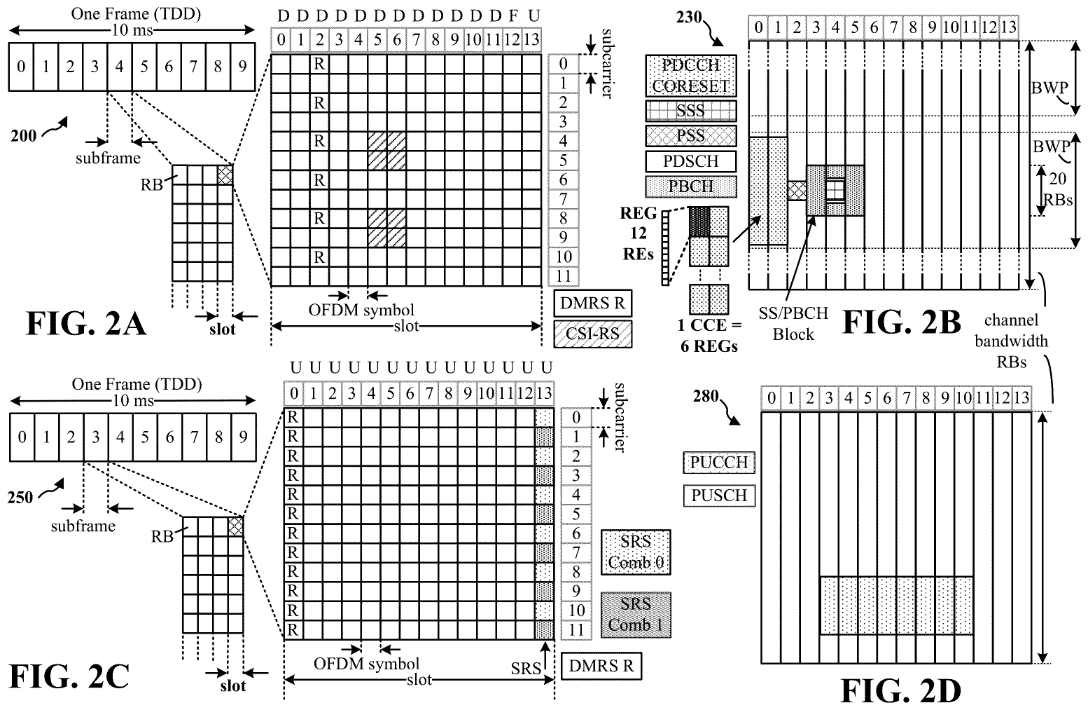

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 us. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

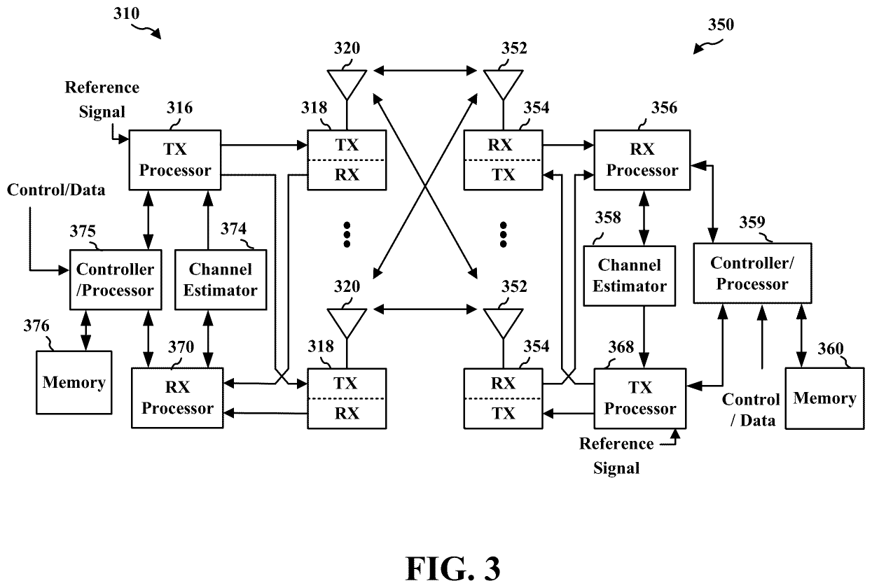

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with 198 of FIG. 1.

At least one of the TX processor 316, the RX processor 370, and the controller/processor 375 may be configured to perform aspects in connection with 199 of FIG. 1.

In wireless communication systems, a UE position may be estimated based on downlink reference signal receiver power (RSRP) measurements taken at the UE, in combination with beam information of the downlink beams of a base station. The measurements of the downlink RSRP may be provided by the UE to a location server which utilizes the measurements and the beam information to determine the positioning of the UE. The location server may determine the position of the UE based on the downlink AoD of the UE and the beam information. However, the estimated positioning of the UE is an angular positioning of the UE with respect to the base station, such that the estimated positioning does not include an estimated distance of the UE with respect to the base station.

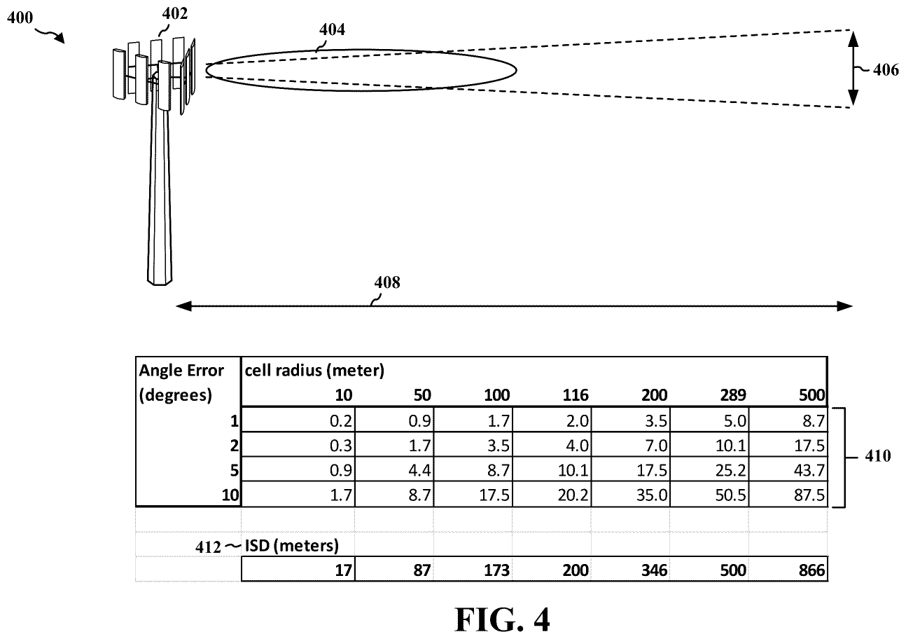

FIG. 4 is a diagram 400 of an angle estimation error. The diagram 400 includes a base station 402 transmitting at least one beam 404 and having a cell radius 408. The base station 402 may transmit the at least one beam 404, but an angular spread 406 of the at least one beam 404 increases the further away a UE is from the base station 402. An angle accuracy should be within a few degrees to provide a noticeable impact to the position accuracy. For example, with an inter-site distance (ISD) 412 of 200 meters, the angle error of 1-2 degrees may result in a position error 410 of less than 4 meters.

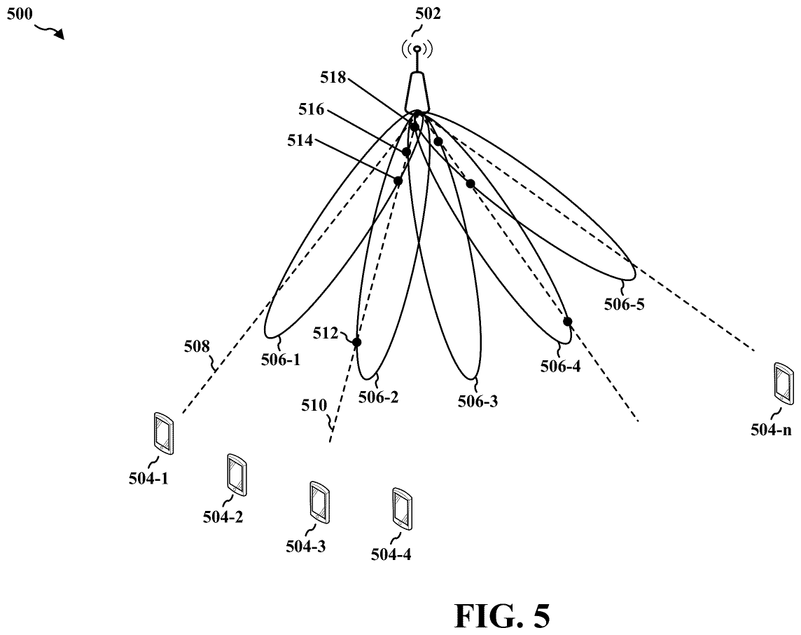

FIG. 5 is a diagram 500 of a downlink AoD of a base station 502. The base station 502 may transmit one or more beams (e.g., 506-1, 506-2, 506-3, 506-4, 506-5) to one or more UEs (e.g., 504-1, 504-2, 504-3, 504-4, . . . , 504-n). To determine the downlink AoD, a UE may measure each beam of the base station 502. For example, for each potential ϕₖ∈[ϕ₁, . . . , ϕ_{N}] where a UE may be located, the UE may calculate the expected receive power P_{i,k} for each beam l∈[1, . . . , N_{beams}] that is being transmitted. The UE may derive a normalized vector Pₖ, for each k∈[1, . . . . N], where the normalized vector is

$${P}_{k} = [ \begin{matrix}\frac{{P}_{i , 1}}{{max}_{l} ( {P}_{i , l} )} \\ ⋮ \\ \frac{{P}_{i , {N}_{beams}}}{{max}_{l} ( {P}_{i , l} )}\end{matrix} ]$$

The normalized vector Pₖ, may comprise a ratio of beams, for example, a main beam against each of the other beams. The UE may report up to 8 RSRPs, one for each positioning reference signal resource. The UE may utilize beam information of the base station, as prior knowledge, to determine the downlink AoD. The UE may compare the results of the normalized vector with the beam information to determine the downlink AoD. The beam information may comprise a database of vectors for different beams transmitted by the base station. For example, UE 504-3 may be at a location that corresponds with ϕ₃ and may measure beams 506-1 to 506-5. The UE 504-3 may measure beam 506-1 against beam 506-2 and result in a ratio value 514. The UE 504-3 may measure beam 506-3 against beam 506-2 and result in a ratio value 516. The UE 504-3 may measure beam 506-4 against beam 506-2 and result in a ratio value 518. The UE 504-3 may measure beam 506-2 against itself which results in a ratio value 512. The comparison of the ratio values 512, 514, 516, 518 against the beam information may lead to a determination of the downlink AoD 510. The results may be provided in a beam response report to a network entity (e.g., location server) to determine the positioning of the UE.

In an effort to reduce overhead of beam response reports, multi-level granularities may be considered. For example, a 2-stage or multi-stage beam response report, where each stage may have a different granularity of a beam information report. The earlier stage may have a larger granularity, while the later stage may have a smaller granularity. For example, in a first stage, the report may comprise beam response for every 5 degrees, while a second stage may report beam responses every 0.5 degrees within each 5-degree section. In some instances, the beam response report at each angle may be a 2-stage or multi-stage beam response report. An amplitude granularity may be coarse at earlier stages, then may become more detailed in later stages. For example, a first stage may have amplitude granularity of 3 dB, while a second stage may have an amplitude granularity reduced to 1 dB. Beam responses with larger granularity may be signaled through broadcast, while beam responses with finer granularity may be signaled through groupcast or unicast. For example, the more detailed beam information may be signaled in groupcast, while the most detailed beam information may be signaled in unicast.

In some instances, the beam response reports may be split into multiple positioning system information blocks (posSIBs), where each posSIB may comprise a beam response report from one or more base stations. In some instances, for each base station, the beam response report may be split into multiple posSIBs. For example, for each base station, the beam response report may be partitioned into several sections, where each section covers part of the angle range. In some instances, the split or group beam response reports across base stations or angle sections may be signaled in unicast or groupcast.

In some instances, for each base station, an absolute beam response of one PRS resource may be reported. The beam responses of other PRS resources may be reported with differential values. The differential report may apply across time, given that the beam pattern may not be changing dynamically. The absolute beam response reports may be reported initially, while subsequent reports for each PRS may only include differential values. In some instances, for each PRS resource, the differential report of beam information may be across the angles. For example, only one of the angles may be reported with an absolute beam amplitude, while the beam amplitude of the other angles may be reported with differential values.

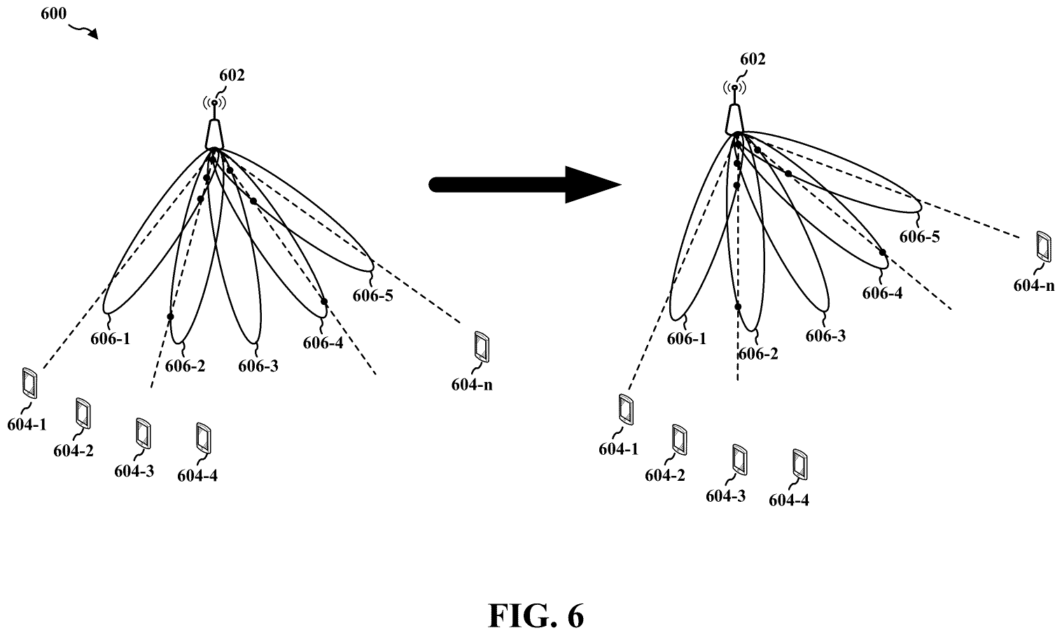

FIG. 6 is a diagram 600 of a changing beam pattern of a base station 602. The diagram 600 includes a base station 602 that transmits a plurality of beams (e.g., 606-1, 606-2, 606-3, 606-4, 606-5) to a plurality of UEs (e.g., 604-1, 604-2, 604-3, 604-4, . . . , 604-n). Over time, each PRS resource may change, such that the downlink AoD is changed. The change of the downlink AoD may be a constant amount (e.g., phi2=phi1+Delta). The assistance data provided by the location server to the one or more UEs (e.g., 604-1, 604-2, 604-3, 604-4,., 604-n) may comprise the delta value to be applied in each step or sequence of delta values to be applied to a particular step.

In some instance, the data size of measurements to be reported may be large such that a base station may easily handle the data transmission to the location server, but transmission of the data may be too much for a UE to perform. As such, the relevant or more important portion of the beam response may be included in the report to reduce signaling while minimizing or limiting an impact on performance. For example, only angles where the gain is within X dB of the peak of the beam may be included in the signal. The value of X may be configurable or pre-determined and signaled to all entities. In some instances, the signal may include the azimuth angle, elevation angle, or gain, which may lead to an increased overhead of two additional fields but minimizes impact on performance in instances where the beamwidths are very small (e.g., few degrees). In some instances, the signal may include a minimum and maximum azimuth angle, a minimum and maximum elevation angle, or a sequence of beam gains within a matrix. In some instances, the signal may include a minimum and maximum azimuth angle, a minimum and maximum elevation angle, a sequence of beam gains within a matrix, or other sparse pairs (e.g., angle, gain) that provide additional features of the beam shape.

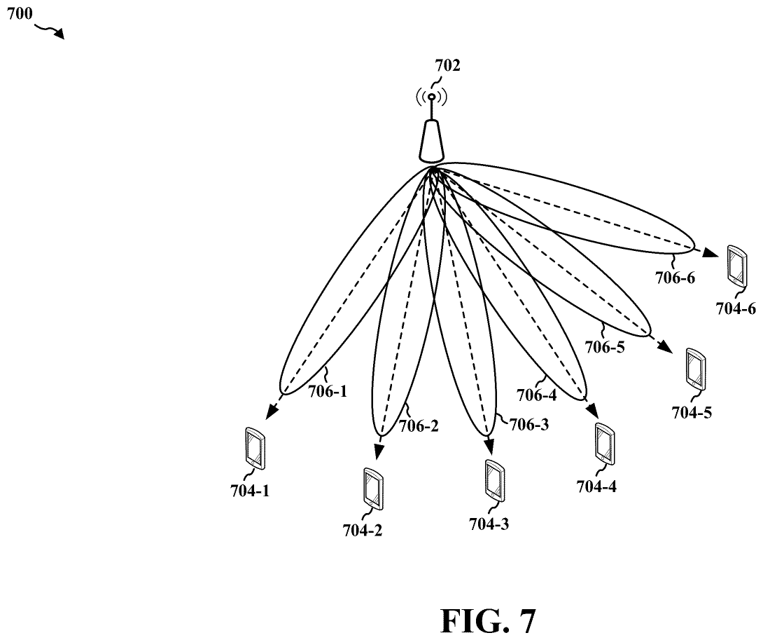

FIG. 7 is a diagram 700 of basis function based signaling. The diagram 700 includes a base station 702 transmitting a plurality of beams (e.g., 706-1, 706-2, 706-3, 706-4, 706-5, 706-6) to a plurality of UEs (e.g., 704-1, 704-2, 704-3, 704-4, 704-5, 704-6). In the diagram 700, the base station 702 may comprise a 6 beam structure to report. Each beam may have a basis function that may approximate the beam. The basis function may provide information indicating the performance of the beam. However, the basis function that corresponds to the beam may indicate the performance of the beam for a specific angle, but the basis function may not be based on the distance of the UE from the base station.

Aspects presented herein provide a configuration that incorporates UE positioning in combination with beam information for identifying a downlink AoD of a base station. For example, a network entity (e.g., location server) may receive a beam response report where the beam response report includes location information of one or more UEs. At least one advantage of the disclosure is that distance information of the UE with respect to the base station may allow for optimization of the downlink beams based on how far the UE may be from the base station. At least another advantage of the disclosure is that that the network entity (e.g., location server) may select a set of downlink AoDs based on the positioning of the UE or direction of travel of the UE. In some aspects, the network entity (e.g., location server) may request a base station or a group of base stations for a beam response report. The beam response report may include positioning information for UEs. For example, the beam response report may include a specific UE distance with respect to the base station, a UE location, or a geography region. The base station may provide the beam response report by taking into account the requested UE positioning information. The base station or group of base stations may respond with multiple beam response reports in a single message that corresponds to multiple UEs.

In some aspects, the network entity (e.g., location server) may provide multiple or alternative downlink AoD beam information associated with a base station to the UE. This may allow the UE to select an appropriate downlink AoD based on its knowledge of the UE location or direction of travel. This may allow for the network entity to provide downlink AoDs that are relevant to the UE based on the positioning of the UE, which may improve performance based on allowing the UE to select downlink AoDs related to the location of the UE or direction of travel.

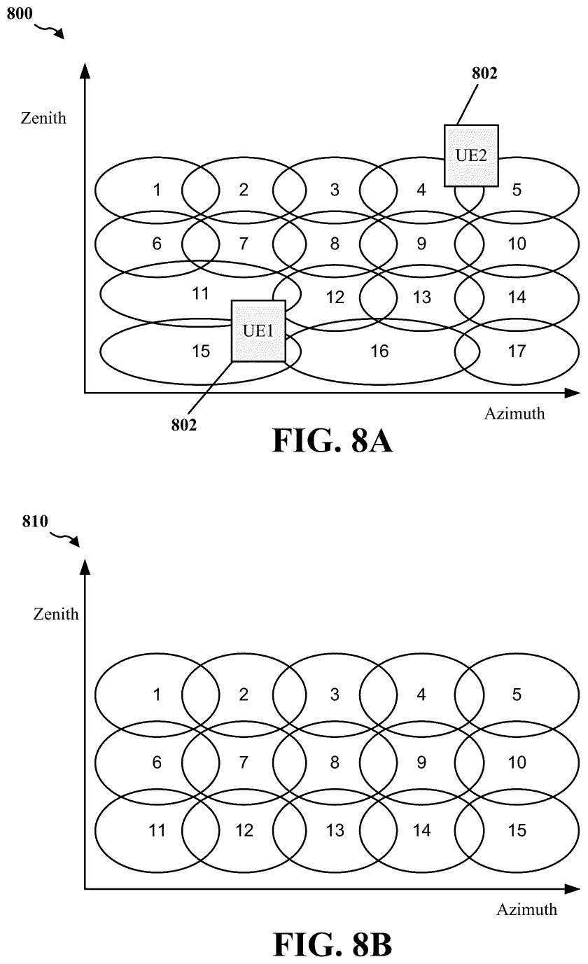

In some aspects, the network entity (e.g., location server) may reduce the number of beams, adjust the number of beams, or the granularity of the beam response based on the distance of the UE from the base station. For example, the network entity may reduce the number of beams of a base station if the UE is close to the base station. In another example, the network entity may increase the number of beams of the base station if the UE is far away from the base station or near the cell edge of the base station. The network entity may adjust the beams via the assistance data. For example, with reference to diagram 800 of FIG. 8A UE1 802 may be close to the base station, such that the network entity may reduce the number of beams of the base station. The reduction of the number of beams for a UE close to the base station may allow the base station to transmit beams having an increased or wider beamwidth that may provide coverage for UEs that are close to the base station. In another example, the UE2 804 may be far from the base station or near the cell edge of the base station, such that the network entity may increase the number of beams of the base station to allow the base station to provide coverage to the UE2 804. The increase in the number of beams may allow the base station to transmit a plurality of beams having a narrow beamwidth that may provide coverage for UEs that are far from the base station. In some aspects, with reference to diagram 810 of FIG. 8B, the UEs may be equidistant from the base station, such that the network entity may adjust the beams of the base station such that all the beams are the same. In some aspects, the base station may be configured to adjust the beams based on the UE positioning information included within the request for the beam response report from the network entity. The base station may adjust the shape of the beams or the number of beams based on the UE positioning information provided in the request for the beam response report from the network entity. For example, for each downlink PRS resource, that base station may inform the network entity one or more additional downlink PRS resources that should be reported. For different distances, UE locations, or regions, the base station may send to the network entity a different collection of associated beams that should be measured.

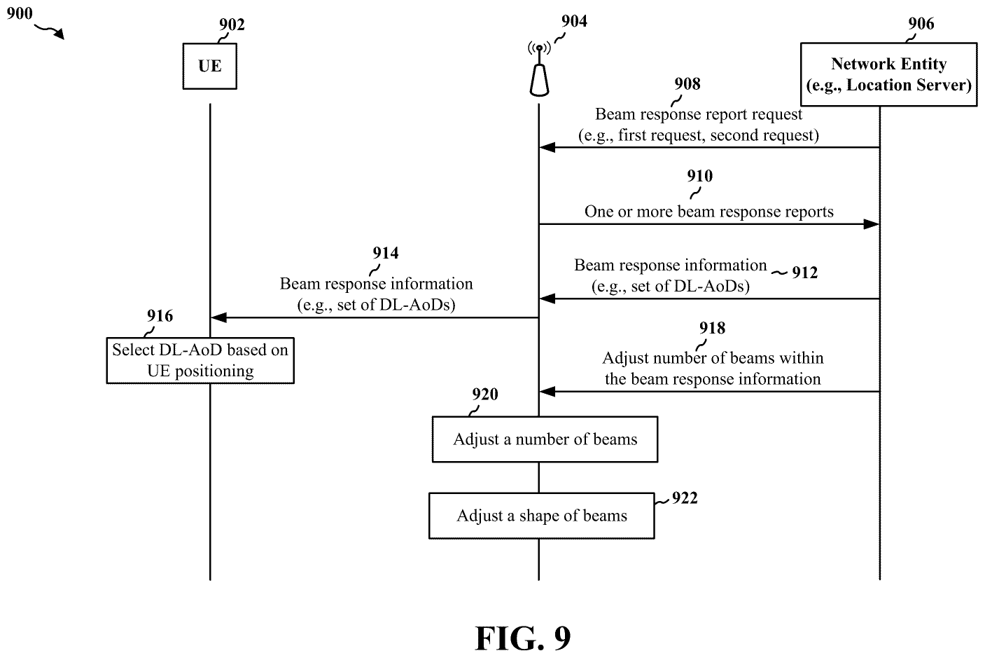

FIG. 9 is a call flow diagram 900 of signaling between a UE 902, a base station 904, and a network entity 906 (e.g., location server, LMF). The base station 904 may be configured to provide at least one cell. The UE 902 may be configured to communicate with the base station 904. For example, in the context of FIG. 1, the base station 904 may correspond to base station 102/180 and, accordingly, the cell may include a geographic coverage area 110 in which communication coverage is provided and/or small cell 102′ having a coverage area 110′. Further, a UE 902 may correspond to at least UE 104. The location server 906 may correspond to the location server 191. In another example, in the context of FIG. 3, the base station 904 may correspond to base station 310 and the UE 902 may correspond to UE 350.

At 908, the network entity (e.g., location server) may request for one or more beam response reports from at least the base station 904. The base station 904 may receive the request for the one or more beam response reports from the location server 906. In some aspects, the network entity may send a first request for a beam response report to the base station. In some aspects, the network entity may send a second request for a beam response report to the base station. The base station may receive the first request or the second request from the network entity. The beam response report may be based on at least the first location information or the second location information of one or more location information. The first request may include one or more location information with respect to the at least one base station. The second request may include the second location information with respect to the at least one base station. The base station 904 may be comprised of a set of base stations. The beam response report may be based on at least the first location information or the second location information of the one or more location information with respect to the at least one base station 904. In some aspects, the one or more location information may comprise at least one of a UE location, a geographic region, or at least one UE distance from the at least one base station 904. The first request or the second request for the beam response report may indicate the UE distance from the at least one base station 904, the geographic region, or the UE positioning with respect to the at least one base station 904. In some aspects, the first request may comprise a plurality of requests. The plurality of requests may have a corresponding location information with respect to the at least one base station. In some aspects, each of the plurality of requests may be separate requests. In some aspects, the one or more location information of the first request may be associated with different distances from the at least one base station. In some aspects, the network entity 906 may comprise a location server, which may comprise an LMF or a server associated with the LMF.

At 910, the base station 904 may provide one or more beam response reports to the network entity 906. The network entity 906 may receive the one or more beam response reports from the base station 904. The one or more beam response reports may be based on at least the first location information or the second location information with respect to the base station 904. The first location information or the second location information may comprise at least one of a UE location, a geographic region, or at least one UE distance from the base station. The one or more beam response reports may comprise beam response information of one or more transmission beams of the at least one base station. The one or more beam response reports may comprise beam response information of the one or more transmission beams of the at least one base station corresponding to at least the first location information of the one or more location information. In some aspects, the one or more location information may correspond to a same DL-AoD with respect to the at least one base station. The one or more location information may correspond to different distances from the at least one base station. The beam response information may comprise a database of received vectors at a UE based on a downlink angle of the at least one base station and the distance of the UE from the at least one base station. The beam response report may comprise a plurality of beam response reports. Each of the plurality of beam response reports may be associated with a respective UE positioning of a plurality of UE positionings.

At 912, the network entity may provide the beam response information for a set of downlink AoDs of the at least one base station to the UE 902, via the base station 904. At 914, the UE 902 may receive the beam response information for the set of downlink AoDs from the network entity 906, via the base station 904. The beam response information may correspond to at least one of the one or more location information. In some aspects, the set of downlink AoDs may comprise a plurality of downlink AoDs of the at least one base station 904. Each of the plurality of downlink AoDs may be related to a different UE positioning. In some aspects, the one or more location information may correspond to a same downlink AoD. The one or more location information may correspond to different distances from the at least one base station. For example, a first location information and a second location information may correspond to different distances from the at least one base station. In some aspects, the one or more location information may correspond to different distances along the same downlink AoD from the at least one base station. In some aspects, the plurality of downlink AoDs may be a subset of a total amount of downlink AoDs of the at least one base station. For example, a subset of downlink AoDs may comprise one or more downlink AoDs that may be comprised of the highest rated possible downlink AoDs for the at least one UE 902, while the remaining downlink AoDs may be determined to not be the highest rated or not suitable downlink AoDs based in part on the UE positioning of the at least one UE 902. For example, some downlink AoDs of the at least one base station 904 that may not correspond to the UE positioning of the at least one UE 902 may not be suitable for the at least one UE 902. In such instances, such downlink AoDs that do not correspond to the UE positioning of the at least one UE 902 may not be provided to the at least one UE 902 in an effort to reduce signaling overhead or optimize spectral efficiency.

At 916, the UE 902 may select a first downlink AoD from the set of downlink AoDs. The UE 902 may select the first downlink AoD from the set of downlink AoDs based at least on the one or more location information with respect to the at least one base station 904. In some aspects, the one or more location information may comprise at least one of a UE location, a geographic region, or at least one UE distance from the at least one base station 904. In some aspects, the first downlink AoD may be selected based on a direction of travel of the UE 902. The UE 902 may communicate with the base station 904 via at least one transmission beam corresponding to the first downlink AoD of the base station 904, after the selection of the first downlink AoD.

At 918, the network entity 906 may adjust a number of beams within the beam response information. The network entity may adjust the number of beams within the beam response information to comprise a subset of beams to correspond to at least the first location information and the second location information from the one or more location information. In some aspects, the number of beams may be adjusted based on the beam response report. The adjustment of the number of beams may comprise reducing or increasing the number of beams based on the UE positioning or distance of the UE 902 from the at least one base station 904. For example, a UE 902 being close to the at least one base station 904 may result in the base station 904 having a reduced amount of beams having a wide beamwidth, whereas a UE 902 being far from the at least one base station 904 or near the cell edge of the at least one base station 904 may result in the at least one base station 904 having an increased amount of beams having a narrow beamwidth. In some aspects, the adjustment of the number of beams may be based on a granularity of the beam response report. In some aspects, the adjustment of the number of beams may comprise reducing or increasing the number of beams such that all the beams have the same beamwidth. For example, in instances where a first UE and a second UE are equidistant from the at least one base station, all the beams may be configured to have the same beamwidth. The adjustment of the beams may be included within the assistance data of the at least one base station 904. The network entity 906 may provide the assistance data with the adjustment of the beams to the at least one base station 904. The at least one base station 904 may receive the assistance data from the network entity 906.

At 920, the base station 904 may adjust a number of transmission beams. The base station 904 may adjust the number of transmission beams based at least on the first location information of the one or more location information. In some aspects, the adjustment of the number of transmission beams may comprise reducing or increasing the number of transmission beams such that the adjusted amount of transmission beams have the same beamwidth. For example, in instances where a first UE and a second UE are equidistant from the at least one base station, the transmission beams may be adjusted to have the same beamwidth. In instances where the first UE and the second UE are at different distances from the at least one base station, the transmission beams may be adjusted to provide one or more transmission beams having wide beamwidths for the UE that is closest to the at least one base station 904, while the transmission beams may be adjusted to provide one or more transmission beams having narrow beamwidths for the UE that is furthest away from the at least one base station 904. In some aspects, the adjustment of the number of transmission beams may comprise reducing or increasing the number of beams based on the first location information or the second location information with respect to the at least one base station. For example, a UE being close to the at least one base station may result in the base station having a reduced amount of transmission beams having a wide beamwidth, whereas a UE being far from the at least one base station or near the cell edge of the at least one base station may result in the at least one base station having an increased amount of transmission beams having a narrow beamwidth. In some aspects, the adjustment of the number of transmission beams may be based on a granularity of the beam response report. The adjustment of the transmission beams may be included within the assistance data of the at least one base station. The network entity may provide, to the base station, the assistance data comprising the adjustment of the transmission beams.

At 922, the base station 904 may adjust a shape of at least one transmission beam. The base station 904 may adjust the shape of the at least one transmission beam based at least on the first location information of the one or more location information. The one or more location information may be included within the request for the beam response report from the network entity 906. In some aspects, the beam response report may comprise an indication indicating a beam adjustment of the at least one transmission beam. In some aspects, for different distances, UE locations, or geographic regions, a subset of transmission beams of the base station 904 may be measured for a positioning reference signal that is the strongest that corresponds to the different distances, UE locations, or geographic regions.

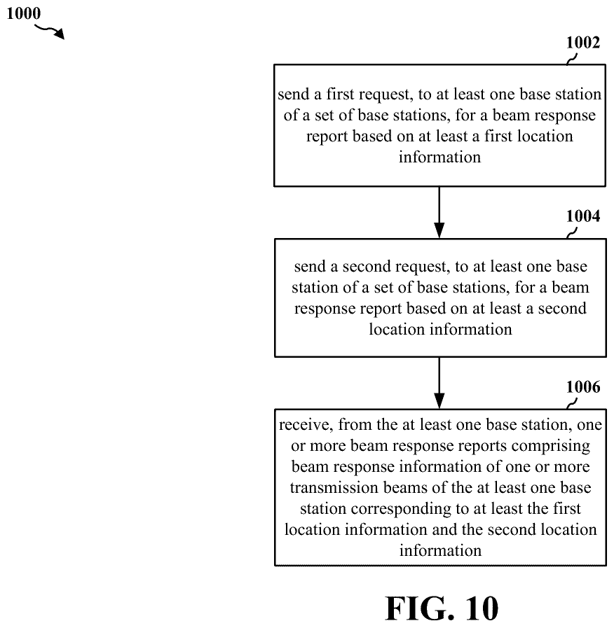

FIG. 10 is a flowchart 1000 of a method of wireless communication. The method may be performed by a network entity (e.g., location server) or a component of a location server (e.g., the location server 191; the apparatus 1202; the baseband unit 1204). One or more of the illustrated operations may be omitted, transposed, or contemporancous. The method may allow a location server to identify at least one downlink AoD of at least one base station based at least on a positioning of a UE from the at least one base station.

At 1002, the network entity may send a first request for a beam response report. For example, 1002 may be performed by request component 1240 of apparatus 1202. The network entity may send the first request for the beam response report to at least one base station of a set of base stations. The beam response report may be based on at least a first location information. The first request may include one or more location information with respect to the at least one base station. In some aspects, the one or more location information may comprise at least one of a UE location, a geographic region, or at least one UE distance from the at least one base station. The first request for the beam response report may indicate the UE distance from the at least one base station, the geographic region, or the UE positioning with respect to the at least one base station. In some aspects, the network entity may comprise a location server, which may comprise an LMF or a server associated with the LMF.

At 1004, the network entity may send a second request for a beam response report. For example, 1004 may be performed by request component 1240 of apparatus 1202. The network entity may send the second request for the beam response report to the at least one base station of the set of base stations. The beam response report may be based on at least a second location information from the one or more location information. The second request may include the second location information with respect to the at least one base station. In some aspects, the second location information may comprise at least one of a UE location, a geographic region, or at least one UE distance from the at least one base station. The second request for the beam response report may indicate the UE distance from the at least one base station, the geographic region, or the UE positioning with respect to the at least one base station. In some aspects, the first request may comprise a plurality of requests. The plurality of requests may have a corresponding location information with respect to the at least one base station. In some aspects, each of the plurality of requests may be separate requests. In some aspects, the one or more location information of the first request may be associated with different distances from the at least one base station.

At 1006, the network entity may receive one or more beam response reports. For example, 1006 may be performed by report component 1242 of apparatus 1202. The network entity may receive the one or more beam response reports from the at least one base station. The one or more beam response reports may comprise beam response information of one or more transmission beams of the at least one base station. The one or more beam response reports may comprise beam response information of the one or more transmission beams of the at least one base station corresponding to at least the first location information of the one or more location information. In some aspects, the one or more location information may correspond to a same DL-AoD with respect to the at least one base station. The one or more location information may correspond to different distances from the at least one base station. The beam response information may comprise a database of received vectors at a UE based on a downlink angle of the at least one base station and the distance of the UE from the at least one base station. In some aspects, the beam response report may comprise a plurality of beam response reports. Each of the plurality of beam response reports may be associated with a respective UE positioning of a plurality of UE positionings.

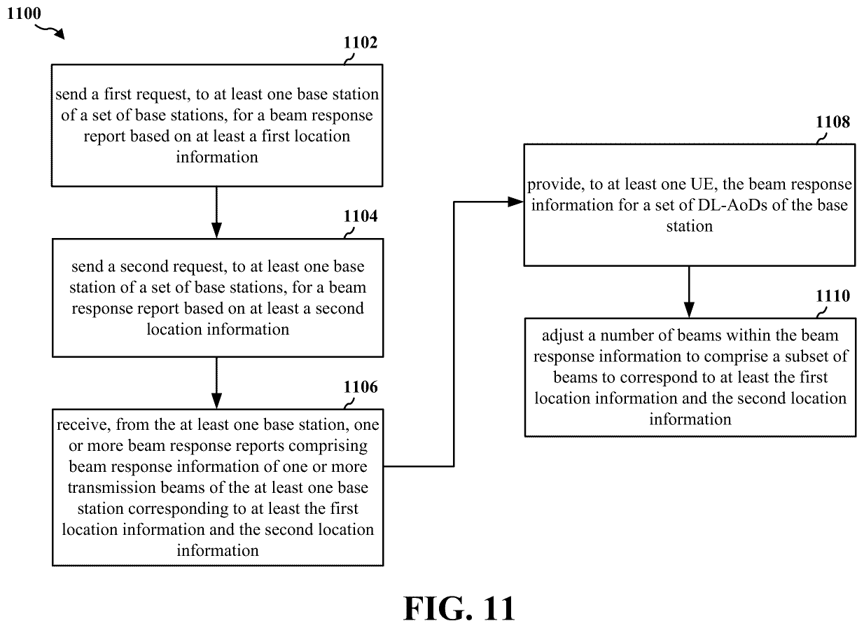

FIG. 11 is a flowchart 1100 of a method of wireless communication. The method may be performed by a network entity (e.g., location server) or a component of a location server (e.g., the location server 191; the apparatus 1202; the baseband unit 1204). One or more of the illustrated operations may be omitted, transposed, or contemporancous. The method may allow a location server to identify at least one downlink AoD of at least one base station based at least on a positioning of a UE from the at least one base station.

At 1102, the network entity may send a first request for a beam response report. For example, 1102 may be performed by request component 1240 of apparatus 1202. The network entity may send the first request for the beam response report to at least one base station of a set of base stations. The beam response report may be based on at least a first location information. The first request may include one or more location information with respect to the at least one base station. In some aspects, the one or more location information may comprise at least one of a UE location, a geographic region, or at least one UE distance from the at least one base station. The first request for the beam response report may indicate the UE distance from the at least one base station, the geographic region, or the UE positioning with respect to the at least one base station. In some aspects, the network entity may comprise a location server, which may comprise an LMF or a server associated with the LMF.

At 1104, the network entity may send a second request for a beam response report. For example, 1104 may be performed by request component 1240 of apparatus 1202. The network entity may send the second request for the beam response report to the at least one base station of the set of base stations. The beam response report may be based on at least a second location information from the one or more location information. The second request may include the second location information with respect to the at least one base station. In some aspects, the second location information may comprise at least one of a UE location, a geographic region, or at least one UE distance from the at least one base station. The second request for the beam response report may indicate the UE distance from the at least one base station, the geographic region, or the UE positioning with respect to the at least one base station. In some aspects, the first request may comprise a plurality of requests. The plurality of requests may have a corresponding location information with respect to the at least one base station. In some aspects, each of the plurality of requests may be separate requests. In some aspects, the one or more location information of the first request may be associated with different distances from the at least one base station. At 1106, the network entity may receive one or more beam response reports. For example, 1106 may be performed by report component 1242 of apparatus 1202. The network entity may receive the one or more beam response reports from the at least one base station. The one or more beam response reports may comprise beam response information of one or more transmission beams of the at least one base station. The one or more beam response reports may comprise beam response information of the one or more transmission beams of the at least one base station corresponding to at least the first location information of the one or more location information. In some aspects, the one or more location information may correspond to a same DL-AoD with respect to the at least one base station. The one or more location information may correspond to different distances from the at least one base station. The beam response information may comprise a database of received vectors at a UE based on a downlink angle of the at least one base station and the distance of the UE from the at least one base station. In some aspects, the beam response report may comprise a plurality of beam response reports. Each of the plurality of beam response reports may be associated with a respective UE positioning of a plurality of UE positionings.

At 1108, the network entity may provide the beam response information for a set of downlink AoDs of the at least one base station. For example, 1108 may be performed by AoD component 1244 of apparatus 1202. The network entity may provide the beam response information for a set of downlink AoDs of the at least one base station to at least one UE. The beam response information may correspond to at least one of the one or more location information. In some aspects, the set of downlink AoDs may comprise a plurality of downlink AoDs of the at least one base station. Each of the plurality of downlink AoDs may be related to a different UE positioning. In some aspects, the one or more location information may correspond to a same downlink AoD. The one or more location information may correspond to different distances from the at least one base station. For example, a first location information and a second location information may correspond to different distances from the at least one base station. In some aspects, the one or more location information may correspond to different distances along the same downlink AoD from the at least one base station. In some aspects, the plurality of downlink AoDs may be a subset of a total amount of downlink AoDs of the at least one base station. For example, a subset of downlink AoDs may comprise one or more downlink AoDs that may be comprised of the highest rated possible downlink AoDs for the at least one UE, while the remaining downlink AoDs may be determined to not be the highest rated or not suitable downlink AoDs based in part on the UE positioning of the at least one UE. For example, some downlink AoDs of the at least one base station that may not correspond to the UE positioning of the at least one UE may not be suitable for the at least one UE. In such instances, such downlink AoDs that do not correspond to the UE positioning of the at least one UE may not be provided to the at least one UE in an effort to reduce signaling overhead or optimize spectral efficiency.

At 1110, the network entity may adjust a number of beams within the beam response information. For example, 1110 may be performed by adjust component 1246 of apparatus 1202. The network entity may adjust the number of beams within the beam response information to comprise a subset of beams to correspond to at least the first location information and the second location information from the one or more location information. In some aspects, the number of beams may be adjusted based on the beam response report. The adjustment of the number of beams may comprise reducing or increasing the number of beams based on the UE positioning or distance of the UE from the at least one base station. For example, a UE being close to the at least one base station may result in the base station having a reduced amount of beams having a wide beamwidth, whereas a UE being far from the at least one base station or near the cell edge of the at least one base station may result in the at least one base station having an increased amount of beams having a narrow beamwidth. In some aspects, the adjustment of the number of beams may be based on a granularity of the beam response report. In some aspects, the adjustment of the number of beams may comprise reducing or increasing the number of beams such that all the beams have the same beamwidth. For example, in instances where a first UE and a second UE are equidistant from the at least one base station, all the beams should be configured to have the same beamwidth. The adjustment of the beams may be included within the assistance data of the at least one base station.

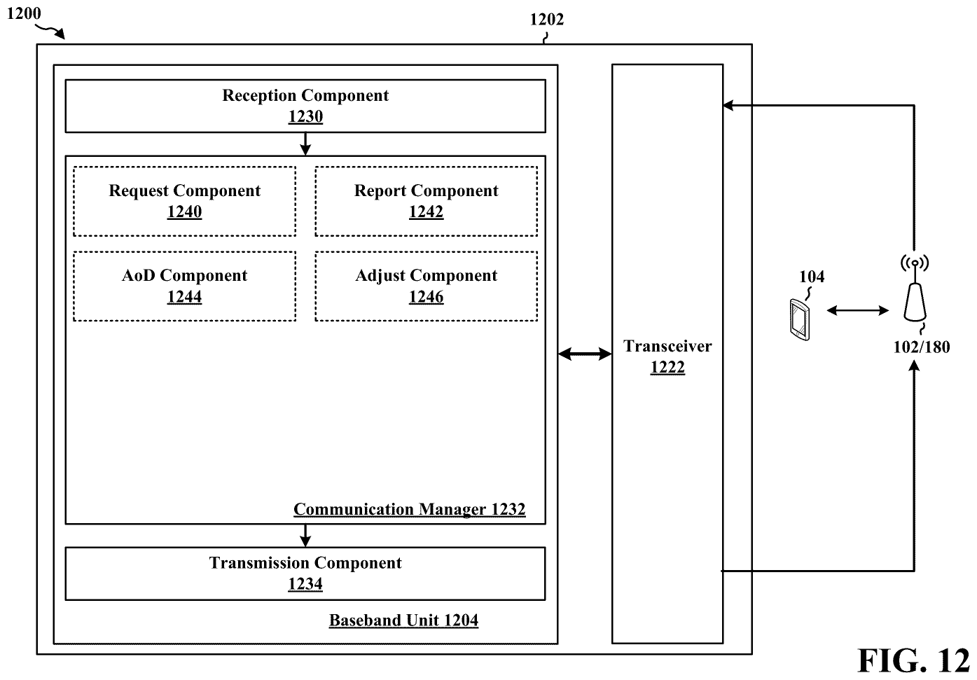

FIG. 12 is a diagram 1200 illustrating an example of a hardware implementation for an apparatus 1202. The apparatus 1202 may be a location server, a component of a location server, or may implement location server functionality. In some aspects, the apparatus 1202 may include a baseband unit 1204. The baseband unit 1204 may communicate through a transceiver 1222 with one or more base stations 102/180. The baseband unit 1204 may include a computer-readable medium/memory. The baseband unit 1204 is responsible for general processing, including the execution of software stored on the computer-readable medium/memory. The software, when executed by the baseband unit 1204, causes the baseband unit 1204 to perform the various functions described supra. The computer-readable medium/memory may also be used for storing data that is manipulated by the baseband unit 1204 when executing software. The baseband unit 1204 further includes a reception component 1230, a communication manager 1232, and a transmission component 1234. The communication manager 1232 includes the one or more illustrated components. The components within the communication manager 1232 may be stored in the computer-readable medium/memory and/or configured as hardware within the baseband unit 1204.

The communication manager 1232 includes a request component 1240 that may send a first request for a beam response report, e.g., as described in connection with 1002 of FIG. 10 or 1102 of FIG. 11. The request component 1240 may be further configured to send a second request for a beam response report, e.g., as described in connection with 1004 of FIG. 10 or 1104 of FIG. 11. The communication manager 1232 further includes a report component 1242 that may receive one or more beam response reports, e.g., as described in connection with 1006 of FIG. 10 or 1106 of FIG. 11. The communication manager 1232 further includes an AoD component 1244 that may provide the beam response information for a set of downlink AoDs of the at least one base station, e.g., as described in connection with 1108 of FIG. 11. The communication manager 1232 further includes an adjust component 1246 that may adjust a number of beams within the beam response information, e.g., as described in connection with 1110 of FIG. 11.

The apparatus may include additional components that perform each of the blocks of the algorithm in the flowcharts of FIGS. 10 and 11. As such, each block in the flowcharts of FIGS. 10 and 11 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1202 may include a variety of components configured for various functions. In one configuration, the apparatus 1202, and in particular the baseband unit 1204, includes means for sending a first request, to at least one base station of a set of base stations, for a beam response report based on at least a first location information. The first request includes one or more location information with respect to the at least one base station. The apparatus includes means for sending a second request, to the at least one base station of the set of base stations, for a beam response report based on at least a second location information. The second request includes one or more location information with respect to the at least one base station. The apparatus includes means for receiving, from the at least one base station, one or more beam response reports comprising beam response information of one or more transmission beams of the at least one base station corresponding to at least the first location information. The apparatus further includes means for providing, to at least one UE, the beam response information for a set of downlink AoDs of the at least one base station. The beam response information corresponds to at least one of the one or more location information. The apparatus further includes means for adjusting a number of beams within the beam response information to comprise a subset of beams to correspond to at least the first location information and a second location information from the one or more location information. The number of beams is adjusted based on the beam response report. The means may be one or more of the components of the apparatus 1202 configured to perform the functions recited by the means.

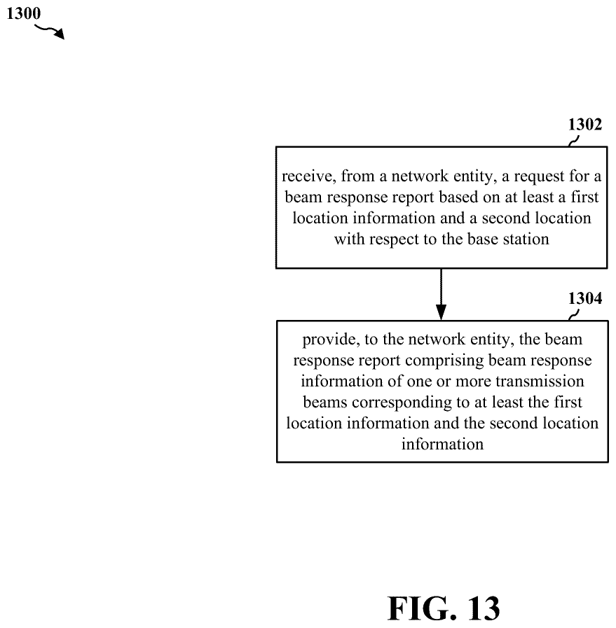

FIG. 13 is a flowchart 1300 of a method of wireless communication. The method may be performed by a base station or a component of a base station (e.g., the base station 102/180; the apparatus 1502; the baseband unit 1504, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to provide a beam response report, to a location server, based on at least a UE positioning of a UE with respect to the base station.

At 1302, the base station may receive a request for a beam response report. For example, 1302 may be performed by request component 1540 of apparatus 1502. The base station may receive the request for the beam response report from a network entity. The network entity may comprise a location server, which may comprise an LMF or a server associated with the LMF. The request for the beam response report may be based on at least a first location information. The request may include one or more location information with respect to the base station. The beam response report may include information related to beam information of the at least one base station. The beam information may comprise a database of received vectors at a UE based on a downlink angle of the at least one base station and the distance of the UE from the at least one base station.

At 1304, the base station may provide the beam response report to the network entity. For example, 1304 may be performed by report component 1542 of apparatus 1502. The beam response report may comprise beam response information of one or more transmission beam corresponding to at least the first location information of the one or more location information. The one or more location information may comprise at least one of a UE location, a geographic region, or at least one UE distance from the base station. The beam response report may comprise a plurality of beam response reports. Each of the plurality of beam response reports may be associated with the one or more location information.

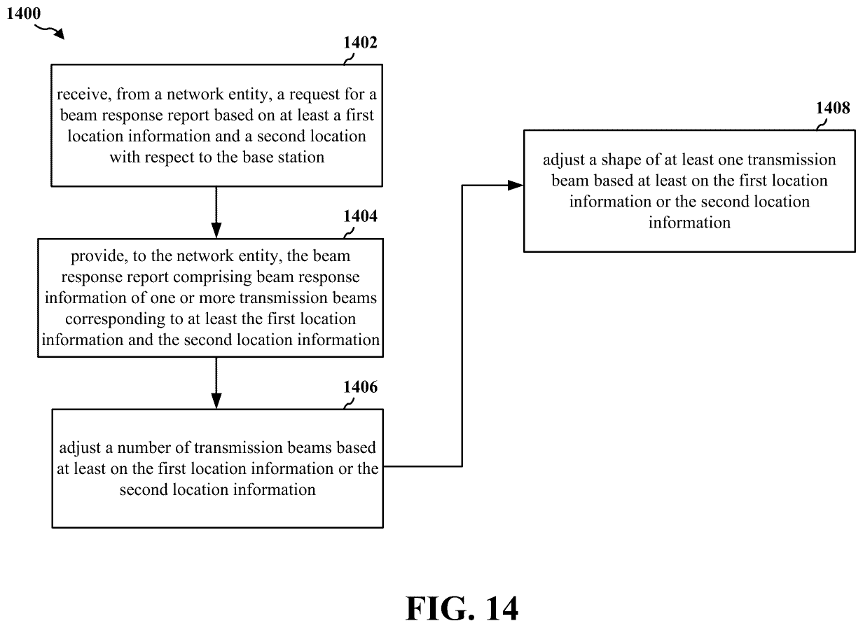

FIG. 14 is a flowchart 1400 of a method of wireless communication. The method may be performed by a base station or a component of a base station (e.g., the base station 102/180; the apparatus 1502; the baseband unit 1504, which may include the memory 376 and which may be the entire base station 310 or a component of the base station 310, such as the TX processor 316, the RX processor 370, and/or the controller/processor 375). One or more of the illustrated operations may be omitted, transposed, or contemporaneous. The method may allow a base station to provide a beam response report, to a location server, based on at least a UE positioning of a UE with respect to the base station.

At 1402, the base station may receive a request for a beam response report. For example, 1402 may be performed by request component 1540 of apparatus 1502. The base station may receive the request for the beam response report from a network entity. The network entity may comprise a location server, which may comprise an LMF or a server associated with the LMF. The request for the beam response report may be based on at least a first location information. The request may include one or more location information with respect to the base station. The beam response report may include information related to beam information of the at least one base station. The beam information may comprise a database of received vectors at a UE based on a downlink angle of the at least one base station and the distance of the UE from the at least one base station.

At 1404, the base station may provide the beam response report to the network entity. For example, 1404 may be performed by report component 1542 of apparatus 1502. The beam response report may comprise beam response information of one or more transmission beam corresponding to at least the first location information of the one or more location information. The one or more location information may comprise at least one of a UE location, a geographic region, or at least one UE distance from the base station. The beam response report may comprise a plurality of beam response reports. Each of the plurality of beam response reports may be associated with the one or more location information.

At 1406, the base station may adjust a number of transmission beams. For example, 1406 may be performed by adjust component 1544 of apparatus 1502. The base station may adjust the number of transmission beams based at least on the first location information of the one or more location information. In some aspects, the adjustment of the number of transmission beams may comprise reducing or increasing the number of transmission beams such that the adjusted amount of transmission beams have the same beamwidth. For example, in instances where a first UE and a second UE are equidistant from the at least one base station, the transmission beams may be adjusted to have the same beamwidth. In instances where the first UE and the second UE are at different distances from the at least one base station, the transmission beams may be adjusted to provide one or more transmission beams having wide beamwidths for the UE that is closest to the at least one base station, while the transmission beams may be adjusted to provide one or more transmission beams having narrow beamwidths for the UE that is furthest away from the at least one base station. In some aspects, the adjustment of the number of transmission beams may comprise reducing or increasing the number of beams based on the first location information or the second location information with respect to the at least one base station. For example, a UE being close to the at least one base station may result in the base station having a reduced amount of transmission beams having a wide beamwidth, whereas a UE being far from the at least one base station or near the cell edge of the at least one base station may result in the at least one base station having an increased amount of transmission beams having a narrow beamwidth. In some aspects, the adjustment of the number of transmission beams may be based on a granularity of the beam response report. The adjustment of the transmission beams may be included within the assistance data of the at least one base station. The network entity may provide, to the base station, the assistance data comprising the adjustment of the transmission beams.

At 1408, the base station may adjust a shape of at least one transmission beam. For example, 1408 may be performed by adjust component 1544 of apparatus 1502. The base station may adjust the shape of the at least one transmission beam based at least on the first location information of the one or more location information. The one or more location information may be included within the request for the beam response report from the network entity. In some aspects, the beam response report may comprise an indication indicating a beam adjustment of the at least one transmission beam. In some aspects, for different distances, UE locations, or geographic regions, a subset of transmission beams of the base station may be measured for a positioning reference signal that is the strongest that corresponds to the different distances, UE locations, or geographic regions.

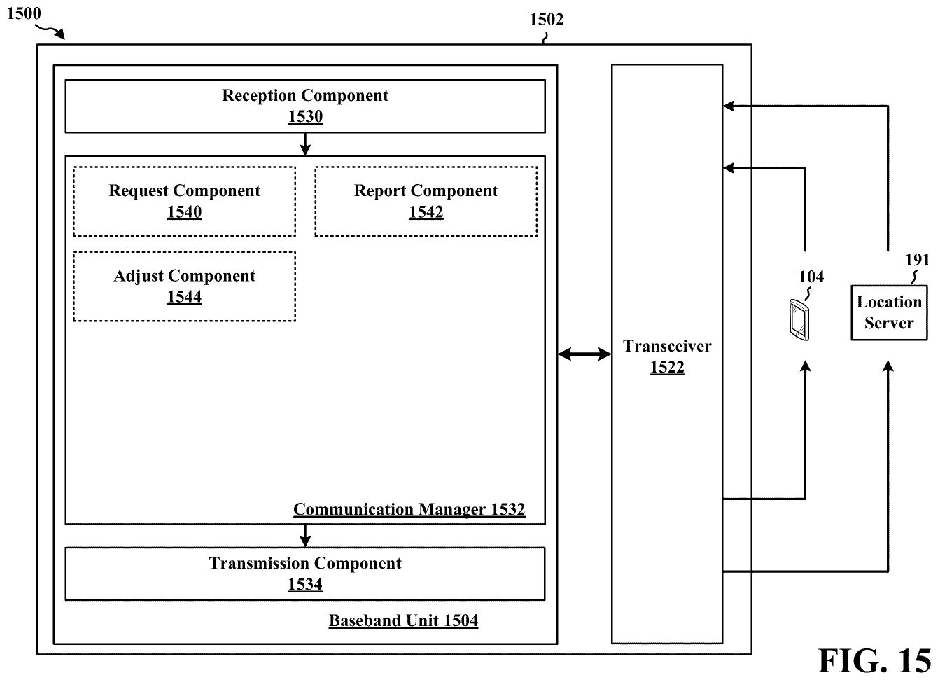

FIG. 15 is a diagram 1500 illustrating an example of a hardware implementation for an apparatus 1502. The apparatus 1502 may be a base station, a component of a base station, or may implement base station functionality. In some aspects, the apparatus 1502 may include a baseband unit 1504. The baseband unit 1504 may communicate through a transceiver 1522 with the UE 104 or the location server 191 (e.g., LMF). The transceiver 1522 may comprise an RF cellular transceiver or may comprise a logical transceiver for communicating with the UE or the location server. The baseband unit 1504 may include a computer-readable medium/memory. The baseband unit 1504 is responsible for general processing, including the execution of software stored on the computer-readable medium/memory. The software, when executed by the baseband unit 1504, causes the baseband unit 1504 to perform the various functions described supra. The computer-readable medium/memory may also be used for storing data that is manipulated by the baseband unit 1504 when executing software. The baseband unit 1504 further includes a reception component 1530, a communication manager 1532, and a transmission component 1534. The communication manager 1532 includes the one or more illustrated components. The components within the communication manager 1532 may be stored in the computer-readable medium/memory and/or configured as hardware within the baseband unit 1504. The baseband unit 1504 may be a component of the base station 310 and may include the memory 376 and/or at least one of the TX processor 316, the RX processor 370, and the controller/processor 375.

The communication manager 1532 includes a request component 1540 that may receive a request for a beam response report, e.g., as described in connection with 1302 of FIG. 13 or 1402 of FIG. 14. The communication manager 1532 further includes a report component 1542 that may provide the beam response report to the network entity e.g., as described in connection with 1304 of FIG. 13 or 1404 of FIG. 14. The communication manager 1532 further includes an adjust component 1544 that may adjust a number of transmission beams, e.g., as described in connection with 1406 of FIG. 14. The adjust component 1544 may be further configured to adjust a shape of at least one transmission beam, e.g., as described in connection with 1408 of FIG. 14.

The apparatus may include additional components that perform each of the blocks of the algorithm in the flowcharts of FIGS. 13 and 14. As such, each block in the flowcharts of FIGS. 13 and 14 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1502 may include a variety of components configured for various functions. In one configuration, the apparatus 1502, and in particular the baseband unit 1504, includes means for receiving, from a network entity, a request for a beam response report based on at least a first location information. The request includes one or more location information with respect to the base station. The apparatus includes means for providing, to the network entity, the beam response report comprising beam response information of one or more transmission beams corresponding to at least the first location information. The apparatus further includes means for adjusting a number of transmission beams based at least on the first location information of the one or more location information. The apparatus further includes means for adjusting a shape of at least one transmission beam based at least on the first location information of the one or more location information. The means may be one or more of the components of the apparatus 1502 configured to perform the functions recited by the means. As described supra, the apparatus 1502 may include the TX Processor 316, the RX Processor 370, and the controller/processor 375. As such, in one configuration, the means may be the TX Processor 316, the RX Processor 370, and the controller/processor 375 configured to perform the functions recited by the means.

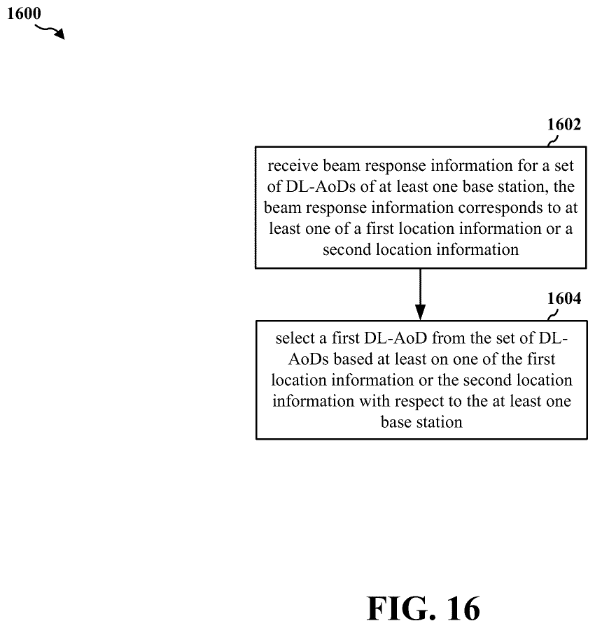

FIG. 16 is a flowchart 1600 of a method of wireless communication. The method may be performed by a UE or a component of a UE (e.g., the UE 104; the apparatus 1702; the cellular baseband processor 1704, which may include the memory 360 and which may be the entire UE 350 or a component of the UE 350, such as the TX processor 368, the RX processor 356, and/or the controller/processor 359). One or more of the illustrated operations may be omitted, transposed, or contemporaneous. The method may allow a UE to select a downlink AoD from a set of downlink AoDs based on the UE positioning or a direction of travel of the UE.

At 1602, the UE may receive beam response information for a set of downlink AoDs of at least one base station. For example, 1602 may be performed by AoD component 1740 of apparatus 1702. The UE may receive the at least one downlink AoD of the at least one base station from the network entity, via the at least one base station. The beam response information may correspond to at least one of one or more location information. In some aspects, the set of downlink AoDs may be a subset of a total amount of downlink AoDs of the at least one base station. For example, a subset of downlink AoDs may comprise one or more downlink AoDs that may be comprised of the highest rated possible downlink AoDs for the UE, while the remaining downlink AoDs may be determined to not be the highest rated or not suitable downlink AoDs based in part on the first location information or the second location information. For example, some downlink AoDs of the at least one base station that may not correspond to the one or more location information may not be suitable for the UE. In such instances, such downlink AoDs that do not correspond to the one or more location information may not be provided to the UE in an effort to reduce signaling overhead or optimize spectral efficiency.

At 1604, the UE may select a first downlink AoD from the set of downlink AoDs. For example, 1604 may be performed by selection component 1742 of apparatus 1702. The UE may select the first downlink AoD from the set of downlink AoDs based at least on the one or more location information with respect to the at least one base station. In some aspects, the one or more location information may comprise at least one of a UE location, a geographic region, or at least one UE distance from the at least one base station. In some aspects, the first downlink AoD may be selected based on a direction of travel of the UE.

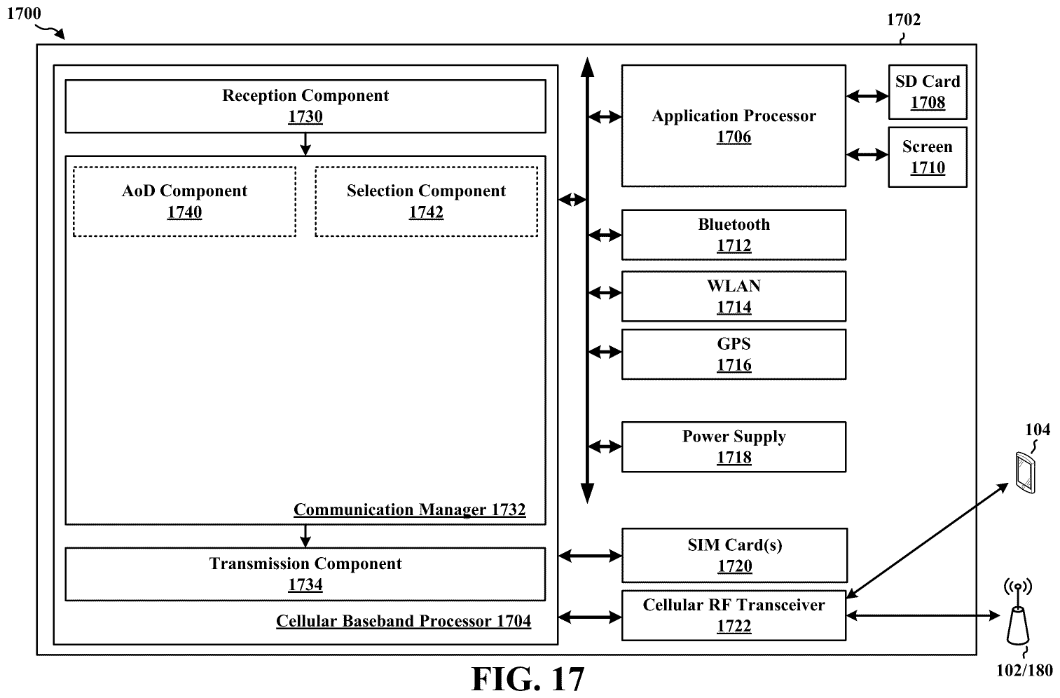

FIG. 17 is a diagram 1700 illustrating an example of a hardware implementation for an apparatus 1702. The apparatus 1702 may be a UE, a component of a UE, or may implement UE functionality. In some aspects, the apparatus 1702 may include a cellular baseband processor 1704 (also referred to as a modem) coupled to a cellular RF transceiver 1722. In some aspects, the apparatus 1702 may further include one or more subscriber identity modules (SIM) cards 1720, an application processor 1706 coupled to a secure digital (SD) card 1708 and a screen 1710, a Bluetooth module 1712, a wireless local area network (WLAN) module 1714, a Global Positioning System (GPS) module 1716, or a power supply 1718. The cellular baseband processor 1704 communicates through the cellular RF transceiver 1722 with the UE 104 and/or BS 102/180. The cellular baseband processor 1704 may include a computer-readable medium/memory. The computer-readable medium/memory may be non-transitory. The cellular baseband processor 1704 is responsible for general processing, including the execution of software stored on the computer-readable medium/memory. The software, when executed by the cellular baseband processor 1704, causes the cellular baseband processor 1704 to perform the various functions described supra. The computer-readable medium/memory may also be used for storing data that is manipulated by the cellular baseband processor 1704 when executing software. The cellular baseband processor 1704 further includes a reception component 1730, a communication manager 1732, and a transmission component 1734. The communication manager 1732 includes the one or more illustrated components. The components within the communication manager 1732 may be stored in the computer-readable medium/memory and/or configured as hardware within the cellular baseband processor 1704. The cellular baseband processor 1704 may be a component of the UE 350 and may include the memory 360 and/or at least one of the TX processor 368, the RX processor 356, and the controller/processor 359. In one configuration, the apparatus 1702 may be a modem chip and include just the baseband processor 1704, and in another configuration, the apparatus 1702 may be the entire UE (e.g., see 350 of FIG. 3) and include the additional modules of the apparatus 1702.

The communication manager 1732 includes an AoD component 1740 that is configured to receive beam response information for a set of downlink AoDs of at least one base station, e.g., as described in connection with 1602 of FIG. 16. The communication manager 1732 further includes a selection component 1742 that is configured to select a first downlink AoD from the set of downlink AoDs, e.g., as described in connection with 1604 of FIG. 16.

The apparatus may include additional components that perform each of the blocks of the algorithm in the flowchart of FIG. 16. As such, each block in the flowchart of FIG. 16 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1702 may include a variety of components configured for various functions. In one configuration, the apparatus 1702, and in particular the cellular baseband processor 1704, includes means for receiving beam response information for a set of downlink AoDs of at least one base station. The beam response information corresponds to at least one of one or more location information. The apparatus includes means for selecting a first downlink AoD from the set of downlink AoDs based at least on one of the one or more location information with respect to the at least one base station. The means may be one or more of the components of the apparatus 1702 configured to perform the functions recited by the means. As described supra, the apparatus 1702 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication at a network entity including at least one processor coupled to a memory and at least one transceiver and configured to send a first request, via the at least one transceiver to at least one base station of a set of base stations, for a beam response report based on at least a first location information, wherein the first request includes one or more location information with respect to the at least one base station; and receive, from the at least one base station, one or more beam response reports comprising beam response information of one or more transmission beams of the at least one base station corresponding to at least the first location information.

Aspect 2 is the apparatus of aspect 1, further includes that the one or more location information corresponds to a same DL-AoD with respect to the at least one base station, wherein the first location information and a second location information correspond to different distances from the at least one base station.

Aspect 3 is the apparatus of any of aspects 1 and 2, further includes that the first request comprises a plurality of requests, wherein the plurality of requests have a corresponding location information with respect to the at least one base station, wherein each of the plurality of requests are separate requests.

Aspect 4 is the apparatus of any of aspects 1-3, further includes that the one or more location information of the first request is associated with different distances from the at least one base station.

Aspect 5 is the apparatus of any of aspects 1-4, further includes that the one or more location information comprises at least one of a UE location, a geographic region, or at least one UE distance from the at least one base station.

Aspect 6 is the apparatus of any of aspects 1-5, further includes that the beam response report comprises a plurality of beam response reports, wherein each of the plurality of beam response reports is associated with at least one of the one or more location information.

Aspect 7 is the apparatus of any of aspects 1-6, further includes that the network entity comprises an LMF or a server associated with the LMF.

Aspect 8 is the apparatus of any of aspects 1-7, further includes that the at least one processor is further configured to provide, to at least one UE, the beam response information for a set of DL-AoDs of the at least one base station, wherein the beam response information corresponds to at least one of the one or more location information.

Aspect 9 is the apparatus of any of aspects 1-8, further includes that the set of DL-AoDs comprises a plurality of DL-AoDs of the at least one base station, wherein each of the plurality of DL-AoDs is related to a different UE positioning.

Aspect 10 is the apparatus of any of aspects 1-9, further includes that the one or more location information correspond to a same DL-AoD, wherein the first location information and a second location information correspond to different distances from the at least one base station.

Aspect 11 is the apparatus of any of aspects 1-10, further includes that the at least one processor is further configured to adjust a number of beams within the beam response information to comprise a subset of beams to correspond to at least the first location information and a second location information from the one or more location information, wherein the number of beams is adjusted based on the beam response report.

Aspect 12 is a method of wireless communication for implementing any of aspects 1-11.

Aspect 13 is an apparatus for wireless communication including means for implementing any of aspects 1-11.

Aspect 14 is a computer-readable medium storing computer executable code, where the code when executed by a processor causes the processor to implement any of aspects 1-11.

Aspect 15 is an apparatus for wireless communication at a base station including at least one processor coupled to a memory and at least one transceiver and configured to receive, from a network entity, a request for a beam response report based on at least a first location information, the request includes one or more location information with respect to the base station; and provide, to the network entity via the at least one transceiver, the beam response report comprising beam response information of one or more transmission beams corresponding to at least the first location information.

Aspect 16 is the apparatus of aspect 15, further includes that the one or more location information comprises at least one of a UE location, a geographic region, or at least one UE distance from the base station.

Aspect 17 is the apparatus of any of aspects 15 and 16, further includes that the beam response report comprises a plurality of beam response reports, wherein each of the plurality of beam response reports is associated with the one or more location information.

Aspect 18 is the apparatus of any of aspects 15-17, further includes that the network entity comprises an LMF or a server associated with the LMF.

Aspect 19 is the apparatus of any of aspects 15-18, further includes that the at least one processor is further configured to adjust a number of transmission beams based at least on the first location information of the one or more location information.

Aspect 20 is the apparatus of any of aspects 15-19, further includes that the at least one processor is further configured to adjust a shape of at least one transmission beam based at least on the first location information of the one or more location information.

Aspect 21 is the apparatus of any of aspects 15-20, further includes that the beam response report comprises an indication indicating a beam adjustment of the at least one beam.

Aspect 22 is a method of wireless communication for implementing any of aspects 15-21.

Aspect 23 is an apparatus for wireless communication including means for implementing any of aspects 15-21.

Aspect 24 is a computer-readable medium storing computer executable code, where the code when executed by a processor causes the processor to implement any of aspects 15-21.

Aspect 25 is an apparatus for wireless communication at a UE including at least one processor coupled to a memory and at least one transceiver and configured to receive beam response information for a set of DL-AoDs of at least one base station, wherein the beam response information corresponds to at least one of one or more location information; and select a first DL-AoD from the set of DL-AoDs based at least on one of the one or more location information with respect to the at least one base station.

Aspect 26 is a method of wireless communication for implementing aspect 25.

Aspect 27 is an apparatus for wireless communication including means for implementing aspect 25.

Aspect 28 is a computer-readable medium storing computer executable code, where the code when executed by a processor causes the processor to implement aspect 25.

What is claimed is:

1. An apparatus for wireless communication at a network entity, comprising:
a memory;
at least one transceiver; and
at least one processor, communicatively connected to the memory and the at least one transceiver, the at least one processor configured to:
send a first request, via the at least one transceiver to at least one base station of a set of base stations, for a beam response report based on at least a first location information, wherein the first request includes one or more location information with respect to the at least one base station; and
receive, from the at least one base station, one or more beam response reports comprising beam response information of one or more transmission beams of the at least one base station corresponding to at least the first location information.

2. The apparatus of claim 1, wherein the one or more location information corresponds to a same downlink angle of departure (DL-AoD) with respect to the at least one base station, wherein the first location information and a second location information correspond to different distances from the at least one base station.

3. The apparatus of claim 1, wherein the first request comprises a plurality of requests, wherein the plurality of requests have a corresponding location information with respect to the at least one base station, wherein each of the plurality of requests are separate requests.

4. The apparatus of claim 1, wherein the one or more location information of the first request is associated with different distances from the at least one base station.

5. The apparatus of claim 1, wherein the one or more location information comprises at least one of a UE location, a geographic region, or at least one UE distance from the at least one base station.

6. The apparatus of claim 1, wherein the beam response report comprises a plurality of beam response reports, wherein each of the plurality of beam response reports is associated with at least one of the one or more location information.

7. The apparatus of claim 1, wherein the network entity comprises a location management function (LMF) or a server associated with the LMF.

8. The apparatus of claim 1, wherein the at least one processor is further configured to:
provide, to at least one user equipment (UE), the beam response information for a set of downlink angle of departures (DL-AoDs) of the at least one base station, wherein the beam response information corresponds to at least one of the one or more location information.

9. The apparatus of claim 8, wherein the set of DL-AoDs comprises a plurality of DL-AoDs of the at least one base station, wherein each of the plurality of DL-AoDs is related to a different UE positioning.

10. The apparatus of claim 8, wherein the one or more location information correspond to a same DL-AoD, wherein the first location information and a second location information correspond to different distances from the at least one base station.

11. The apparatus of claim 8, wherein the at least one processor is further configured to:
adjust a number of beams within the beam response information to comprise a subset of beams to correspond to at least the first location information and a second location information from the one or more location information, wherein the number of beams is adjusted based on the beam response report.

12. A method of wireless communication at a network entity, comprising:
sending a first request, to at least one base station of a set of base stations, for a beam response report based on at least a first location information, wherein the first request includes one or more location information with respect to the at least one base station; and
receiving, from the at least one base station, one or more beam response reports comprising beam response information of one or more transmission beams of the at least one base station corresponding to at least the first location information.

13. The method of claim 12, wherein the one or more location information corresponds to a same downlink angle of departure (DL-AoD) with respect to the at least one base station, wherein the first location information and a second location information correspond to different distances from the at least one base station.

14. The method of claim 12, wherein the first request comprises a plurality of requests, wherein the plurality of requests have a corresponding location information with respect to the at least one base station, wherein each of the plurality of requests are separate requests.

15. The method of claim 12, wherein the one or more location information of the first request is associated with different distances from the at least one base station.

16. The method of claim 12, wherein the one or more location information comprises at least one of a UE location, a geographic region, or at least one UE distance from the at least one base station.

17. The method of claim 12, wherein the beam response report comprises a plurality of beam response reports, wherein each of the plurality of beam response reports is associated with at least one of the one or more location information.

18. The method of claim 12, wherein the network entity comprises a location management function (LMF) or a server associated with the LMF.

19. The method of claim 12, further comprising:
providing, to at least one user equipment (UE), the beam response information for a set of downlink angle of departures (DL-AoDs) of the at least one base station, wherein the beam response information corresponds to at least one of the one or more location information.

20. The method of claim 19, wherein the set of DL-AoDs comprises a plurality of DL-AoDs of the at least one base station, wherein each of the plurality of DL-AoDs is related to a different UE positioning.

21. The method of claim 19, wherein the one or more location information correspond to a same DL-AoD, wherein the first location information and the second location information correspond to different distances from the at least one base station.

22. The method of claim 19, further comprising:
adjusting a number of beams within the beam response information to comprise a subset of beams to correspond to at least the first location information and a second location information from the one or more location information, wherein the number of beams is adjusted based on the beam response report.

23. An apparatus for wireless communication at a base station, comprising:
a memory;
at least one transceiver; and
at least one processor, communicatively connected to the memory and the at least one transceiver, the at least one processor configured to:
receive, from a network entity, a request for a beam response report based on at least a first location information, the request includes one or more location information with respect to the base station; and
provide, to the network entity via the at least one transceiver, the beam response report comprising beam response information of one or more transmission beams corresponding to at least the first location information.

24. The apparatus of claim 23, wherein the one or more location information comprises at least one of a UE location, a geographic region, or at least one UE distance from the base station.

25. The apparatus of claim 23, wherein the beam response report comprises a plurality of beam response reports, wherein each of the plurality of beam response reports is associated with the one or more location information.

26. The apparatus of claim 23, wherein the network entity comprises a location management function (LMF) or a server associated with the LMF.

27. The apparatus of claim 23, wherein the at least one processor is further configured to:
adjust a number of transmission beams based at least on the first location information of the one or more location information.

28. The apparatus of claim 23, wherein the at least one processor is further configured to:
adjust a shape of at least one transmission beam based at least on the first location information of the one or more location information.

29. The apparatus of claim 28, wherein the beam response report comprises an indication indicating a beam adjustment of the at least one beam.

30. An apparatus for wireless communication at a user equipment (UE), comprising:
a memory;
at least one transceiver; and
at least one processor, communicatively connected to the memory and the at least one transceiver, the at least one processor configured to:
receive beam response information for a set of downlink angle of departures (DL-AoDs) of at least one base station, wherein the beam response information corresponds to at least one of one or more location information; and
select a first DL-AoD from the set of DL-AoDs based at least on one of the one or more location information with respect to the at least one base station.
